(19) United States
(12) Patent Application Publication
(10) Pub. No.: US 2018/0179961 A1
(43) Pub. Date: Jun. 28, 2018

(54) TURBINE ENGINE ASSEMBLY AND METHOD OF OPERATING

(71) Applicant: General Electric Company, Schenectady, NY (US)

(72) Inventors: Thomas Michael Lavertu, Jr., Clifton Park, NY (US); Kapil Kumar Singh, Rexford, NY (US); Venkat Eswarlu Tangirala, Niskayuna, NY (US); Michael John Bowman, Niskayuna, NY (US); Joel Meier Haynes, Niskayuna, NY (US); Anthony John Dean, Scotia, NY (US)

(21) Appl. No.: 15/390,035

(22) Filed: Dec. 23, 2016

(51) Int. Cl. F02C 9/40; F02C 3/22; F02C 3/30; F02C 3/16; F02C 5/00; F02C 7/22

(52) U.S. Cl. CPC F02C 9/40; F02C 3/22; F02C 3/305; F05D 2240/35; F02C 5/00; F02C 7/22; F05D 2220/32; F02C 3/165

(57) ABSTRACT

A turbine engine assembly including a rotating detonation combustor configured to combust a fuel-air mixture formed at least partially from a primary fuel including methane. The assembly also includes a fuel reformer configured to produce a secondary fuel, wherein the fuel reformer is further configured to channel a flow of secondary fuel towards the rotating detonation combustor such that the fuel-air mixture further includes the secondary fuel.

### BACKGROUND

The present disclosure relates generally to rotating detonation combustion systems and, more specifically, to systems and methods of initiating and sustaining detonative combustion at certain operating conditions of a gas turbine engine.

In rotating detonation engines and, more specifically, in rotating detonation combustors, a mixture of fuel and an oxidizer is ignited such that combustion products are formed. For example, the combustion process begins when the fuel-oxidizer mixture in a tube or a pipe structure is ignited via a spark or another suitable ignition source to generate a compression wave. The compression wave is followed by a chemical reaction that transitions the compression wave to a detonation wave. The detonation wave enters a combustion chamber of the rotating detonation combustor and travels along the combustion chamber. Air and fuel are separately fed into the rotating detonation combustion chamber and are consumed by the detonation wave. As the detonation wave consumes air and fuel, combustion products traveling along the combustion chamber accelerate and are discharged from the combustion chamber. However, facilitating detonation of a fuel-oxidizer mixture containing methane, for example, can be a difficult task at certain operating conditions of rotating detonation gas turbine engines.

### BRIEF DESCRIPTION

In one aspect, a turbine engine assembly is provided. The assembly includes a rotating detonation combustor configured to combust a fuel-air mixture formed at least partially from a primary fuel including methane. The assembly also includes a fuel reformer configured to produce a secondary fuel, wherein the fuel reformer is further configured to channel a flow of secondary fuel towards the rotating detonation combustor such that the fuel-air mixture further includes the secondary fuel.

In another aspect, a method of operating a turbine engine assembly is provided. The method includes producing secondary fuel in a fuel reformer, channeling a flow of secondary fuel from the fuel reformer towards a rotating detonation combustor, and combusting, in the rotating detonation combustor, a fuel-air mixture formed at least partially from a primary fuel including methane, and the secondary fuel.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of an exemplary combined cycle power generation system;

FIG. 2 is a schematic illustration of an exemplary rotating detonation combustion system that may be used in the gas turbine engine assembly shown in FIG. 1; and

FIG. 3 is a schematic illustration of an alternative rotating detonation combustion system that may be used in the gas turbine engine assembly shown in FIG. 1.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

Embodiments of the present disclosure relate to systems and methods of initiating and sustaining detonative combustion at certain operating conditions of a gas turbine engine. More specifically, the systems described herein include a rotating detonation combustor and a fuel reformer. The rotating detonation combustor combusts a fuel-air mixture, and the fuel reformer selectively channels secondary fuel towards the rotating detonation combustor based on an operating condition of the gas turbine engine. For example, rotating detonation combustors are sized to produce detonations from a fuel-air mixture having a cell size defined within a predetermined range. The cell size of the fuel-air mixture is based at least partially on an inlet pressure and an inlet temperature at the rotating detonation combustor, and an equivalence ratio (i.e., a fuel-to-air ratio) of the fuel-air mixture, and it is generally difficult to detonate fuel-air mixtures when inlet pressures and temperatures for the gas turbine are relatively low at low load conditions. In addition, fuel such as methane has a relatively large cell size that makes it difficult to achieve detonative combustion at low temperatures and pressures. In other words, the cell size of the fuel-air mixture sometimes falls outside the predetermined range for the rotating detonation combustor when operating at low load conditions. The fuel reformer is operable to dope the fuel-air mixture with hydrogen, for example, to facilitate improving the detonability of the rotating detonation combustor. For example, hydrogen has a smaller cell size than methane such that doping the primary fuel with secondary fuel facilitates reducing the overall cell size of the fuel. As such, the rotating detonation combustor is capable of producing detonations over a wider range of operating conditions.

As used herein, “detonation” and “quasi-detonation” may be used interchangeably. Typical embodiments of detonation chambers include a means of igniting a fuel/oxidizer mixture, for example a fuel/air mixture, and a confining chamber, in which pressure wave fronts initiated by the ignition process coalesce to produce a detonation wave. Each detonation or quasi-detonation is initiated either by external ignition, such as spark discharge or laser pulse, or by gas dynamic processes, such as shock focusing, autoignition or by another detonation via cross-firing. The geometry of the detonation chamber is such that the pressure rise of the detonation wave expels combustion products out the detonation chamber exhaust to produce a thrust force. In addition, rotating detonation combustors are designed such that a substantially continuous detonation wave is produced and discharged therefrom. As known to those skilled in the art, detonation may be accomplished in a number of types of detonation chambers, including detonation tubes, shock tubes, resonating detonation cavities, and annular detonation chambers.

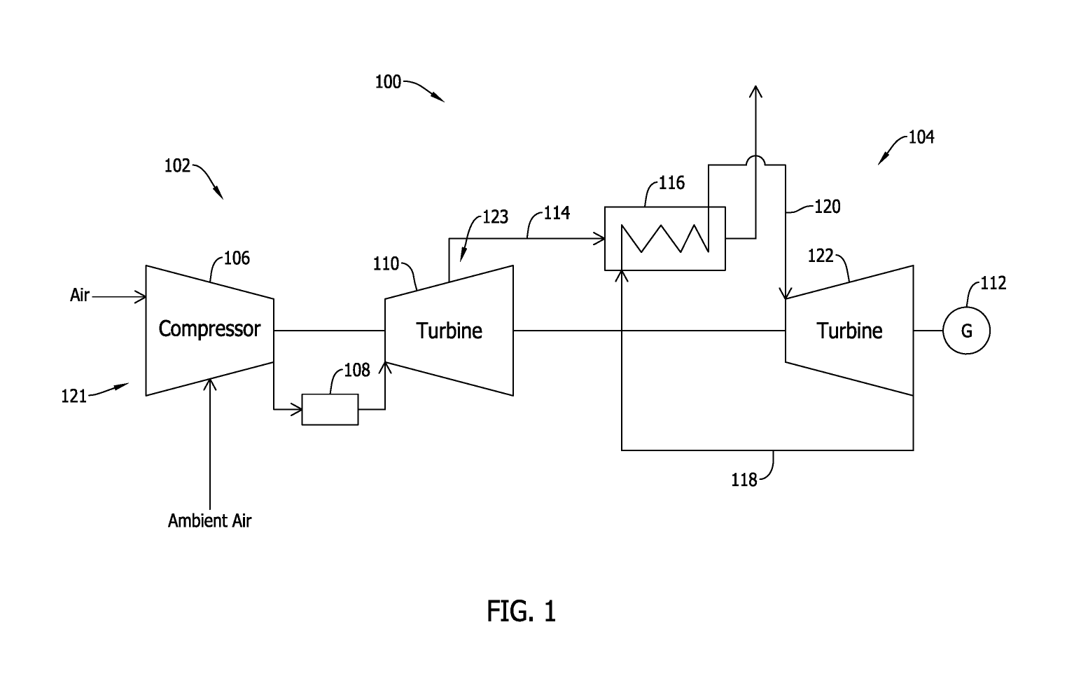

FIG. 1 is a schematic illustration of an exemplary combined cycle power generation system 100. Power generation system 100 includes a gas turbine engine assembly 102 and a steam turbine engine assembly 104. Gas turbine engine assembly 102 includes a compressor 106, a combustor 108, and a first turbine 110 powered by expanding hot gas produced in combustor 108 for driving an electrical generator 112. Exhaust gas 114 is channeled from first turbine 110 towards a heat recovery steam generator (HRSG) 116 for recovering waste heat from exhaust gas 114. More specifically, HRSG 116 transfers heat from exhaust gas 114 to water/steam 118 channeled through HRSG 116 to produce steam 120. Steam turbine engine assembly 104 includes a second turbine 122 that receives steam 120, which powers second turbine 122 for further driving electrical generator 112.

In operation, air enters gas turbine engine assembly 102 through an intake 121 and is channeled through multiple stages of compressor 106 towards combustor 108. Compressor 106 compresses the air and the highly compressed air is channeled from compressor 106 towards combustor 108 and mixed with fuel. The fuel-air mixture is combusted within combustor 108. High temperature combustion gas generated by combustor 108 is channeled towards first turbine 110. Exhaust gas 114 is subsequently discharged from first turbine 110 through an exhaust 123.

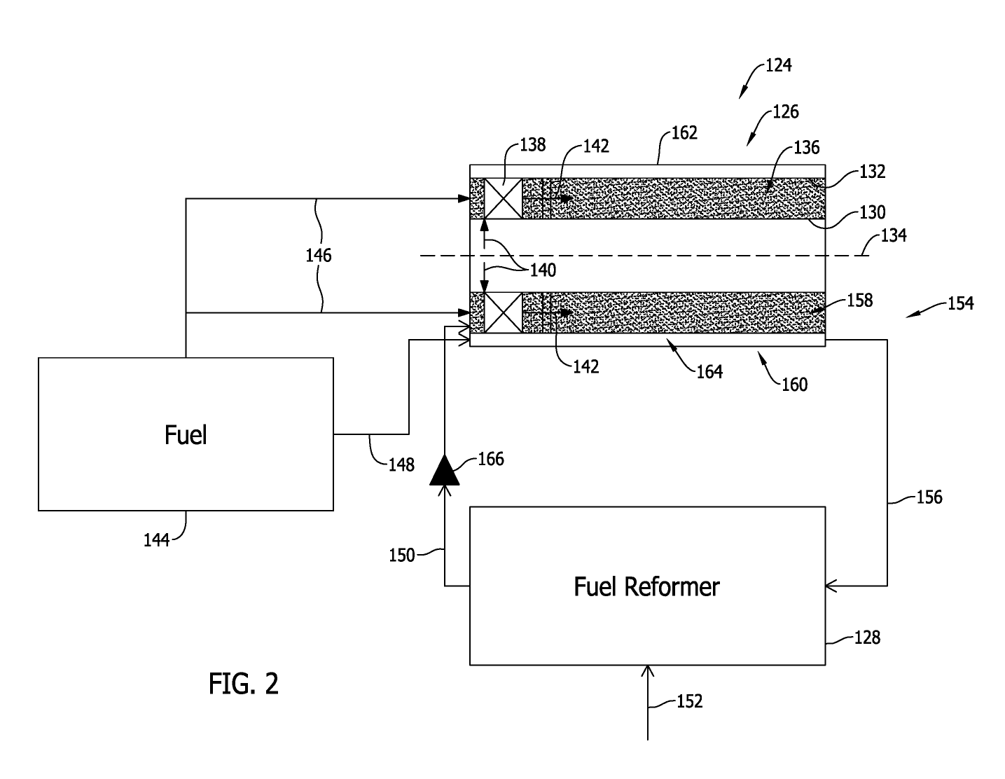

FIG. 2 is a schematic illustration of an exemplary rotating detonation combustion (RDC) system 124 that may be used in gas turbine engine assembly 102 (shown in FIG. 1). In the exemplary embodiment, RDC system 124 includes a rotating detonation combustor 126 (i.e., combustor 108 (shown in FIG. 1)) and a fuel reformer 128. Rotating detonation combustor 126 includes a radially inner side wall 130 and a radially outer side wall 132 that both extend circumferentially relative to a centerline 134 of rotating detonation combustor 126. As such, an annular combustion chamber 136 is defined between radially inner side wall 130 and radially outer side wall 132. In addition, rotating detonation combustor 126 includes a fuel-air mixer 138 coupled within annular combustion chamber 136. Fuel-air mixer 138 receives fuel, as will be explained in more detail below, and air 140, and rotating detonation combustor 126 combusts a fuel-air mixture 142 discharged from fuel-air mixer 138.

In further embodiments, annular combustion chamber 136 is any suitable geometric shape and does not necessarily include an inner liner and/or center body. For example, in some embodiments, annular combustion chamber 136 is substantially cylindrical.

RDC system 124 further includes a source 144 of fuel, such as natural gas containing methane. Source 144 of fuel is coupled in flow communication with rotating detonation combustor 126 and fuel reformer 128. As such, source 144 of fuel provides a flow of primary fuel 146 to rotating detonation combustor 126 for forming fuel-air mixture 142. In addition, source 144 of fuel provides a flow of reforming fuel 148 to fuel reformer 128 to facilitate forming a secondary fuel 150 for injection into rotating detonation combustor 126, as will be explained in more detail below.

In the exemplary embodiment, fuel reformer 128 receives the flow of reforming fuel 148, either directly or indirectly from source 144 of fuel, and a flow of catalyst 152. Exemplary catalysts include, but are not limited to, oxygen and steam. In one embodiment, fuel reformer 128 reacts reforming fuel 148 and catalyst 152 to produce secondary fuel 150. More specifically, methane in reforming fuel 148 and one of oxygen or steam are reacted to produce carbon monoxide (not shown) and hydrogen as secondary fuel 150, for example. Fuel reformer 128 then channels a flow of secondary fuel 150 towards rotating detonation combustor 126 for injection therein. As such, in some embodiments, the fuel in fuel-air mixture 142 is formed from primary fuel 146 and secondary fuel 150, as will be explained in more detail below.

In one embodiment, fuel reformer 128 receives the flow of reforming fuel 148 indirectly from source 144 of fuel. More specifically, RDC system 124 further includes a heat exchange assembly 154 that receives the flow of reforming fuel 148 from source 144, transfers heat from rotating detonation combustor 126 to reforming fuel 148 such that a flow of heated fuel 156 is formed, and channels the flow of heated fuel 156 towards fuel reformer 128. As such, cooling is provided to rotating detonation combustor 126 and the efficiency of the reforming process in fuel reformer 128 is increased.

In the exemplary embodiment, heat exchange assembly 154 is at least partially integrated with rotating detonation combustor 126. For example, heat exchange assembly 154 includes a hot side 158 and a cold side 160, and rotating detonation combustor 126 includes heat exchange assembly 154 integrated therewith such that hot side 158 is defined by a portion of rotating detonation combustor 126. More specifically, in one embodiment, heat exchange assembly 154 includes an annular jacket 162 coupled to and extending about radially outer side wall 132, thereby defining a heating chamber 164 therebetween. As such, annular combustion chamber 136 defines hot side 158 of heat exchange assembly 154, and heating chamber 164 defines cold side 160 of heat exchange assembly 154.

In operation, heat generated by the combustion of fuel-air mixture 142 in annular combustion chamber 136 is transferred towards heating chamber 164 through radially outer side wall 132 via conduction. Source 144 of fuel channels the flow of reforming fuel 148 towards heat exchange assembly 154 and, more specifically, through heating chamber 164. As such, heat from the combustion of fuel-air mixture 142 is absorbed by reforming fuel 148 such that heated fuel 156 is formed.

As described above, secondary fuel 150 is selectively channeled towards rotating detonation combustor 126 based on an operating condition of gas turbine engine assembly 102. In the exemplary embodiment, RDC system 124 further includes a flow controller 166 coupled between rotating detonation combustor 126 and fuel reformer 128. Flow controller 166 regulates the flow of secondary fuel 150 channeled towards rotating detonation combustor 126 based on an operating condition of gas turbine engine assembly 102. For example, flow controller 166 is operable to allow the flow of secondary fuel 150 towards rotating detonation combustor 126 at least one of at startup or as a rotational speed of gas turbine engine assembly 102 increases towards a steady state operation. As such, injection of secondary fuel 150 into rotating detonation combustor 126 facilitates reducing the cell size of fuel-air mixture 142 such that rotating detonation combustor 126 is capable of producing detonations at low load conditions of gas turbine engine assembly 102.

In addition, flow controller 166 is operable to progressively reduce an amount of secondary fuel 150 channeled towards rotating detonation combustor 126 as the rotational speed of gas turbine engine assembly 102 increases towards the steady state operating condition. For example, the need for injection of secondary fuel 150 decreases as gas turbine engine assembly 102 reaches the steady state operating condition and the temperature and pressure of fuel-air mixture 142 increases. As such, in one embodiment, flow controller 166 is further operable for stopping the flow of secondary fuel 150 channeled towards rotating detonation combustor 126 when gas turbine engine assembly 102 reaches the steady state operating condition.

Moreover, as described above, rotating detonation combustor 126 is capable of producing detonations from fuel-air mixtures having a cell size defined within a predetermined range of cell sizes. In one embodiment, flow controller 166 is operable to regulate the flow of secondary fuel 150 such that the cell size of fuel-air mixture 142 is within the predetermined range of cell sizes for rotating detonation combustor 126.

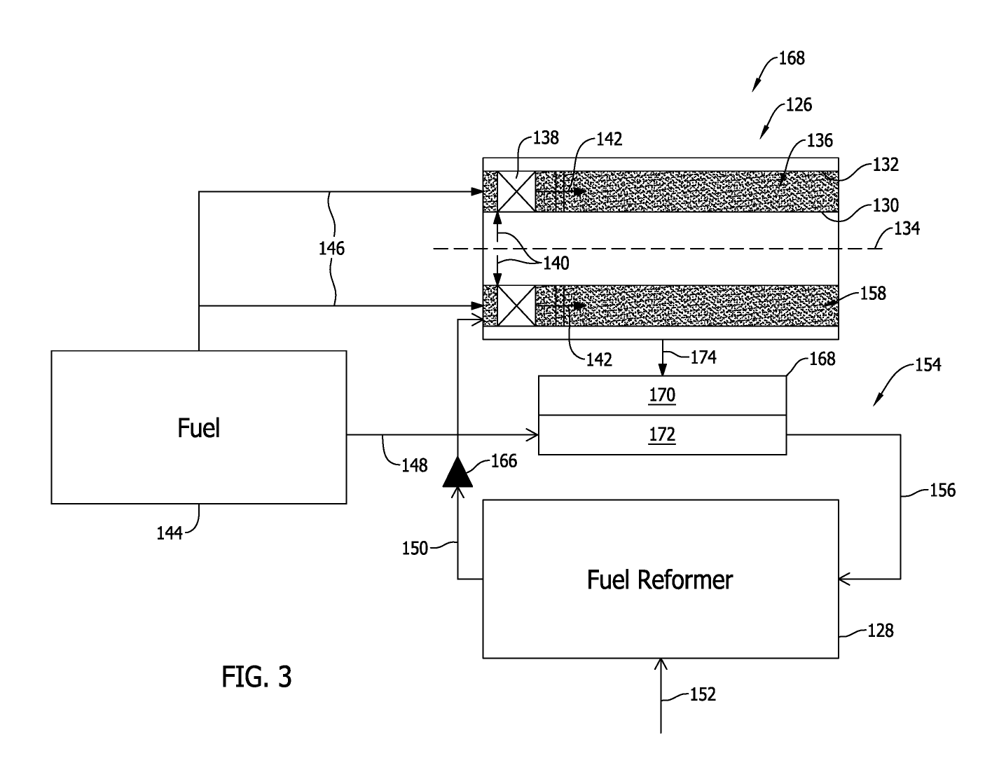

FIG. 3 is a schematic illustration of an alternative rotating detonation combustion (RDC) system 168 that may be used in gas turbine engine assembly 102 (shown in FIG. 1). In the exemplary embodiment, heat exchange assembly 154 includes a heat exchanger 168 located remote from rotating detonation combustor 126. Heat exchanger 168 includes a hot side 170 and a cold side 172. In operation, heat 174 generated by the combustion of fuel-air mixture 142 in annular combustion chamber 136 is transferred towards hot side 170 of heat exchanger 168 by any suitable means. Suitable means for transferring heat 174 include, but are not limited to, heat pipes and a thermally conductive member. Source 144 of fuel channels the flow of reforming fuel 148 towards heat exchange assembly 154 and, more specifically, through cold side 172 of heat exchanger 168. As such, heat 174 from the combustion of fuel-air mixture 142 is absorbed by reforming fuel 148 such that heated fuel 156 is formed.

The systems and methods described herein facilitate producing detonations in a RDC system over a wide range of operating conditions for a gas turbine engine. More specifically, the RDC systems described herein include a methane fuel reformer that produces a secondary fuel, such as hydrogen. When mixed with a primary fuel for the RDC system, the cell size of the resulting fuel-air mixture is reduced such that detonation production is facilitated at low load conditions. As such, detonability of the rotating detonation combustor is improved.

An exemplary technical effect of the systems and methods described herein includes at least one of: (a) enabling detonation production over a wide range of operating conditions; (b) enabling RDC operation at lower equivalence ratios; and (c) providing cooling for the rotating detonation combustor.

Exemplary embodiments of RDC systems are provided herein. The systems and methods are not limited to the specific embodiments described herein, but rather, components of systems and/or steps of the methods may be utilized independently and separately from other components and/or steps described herein. For example, the configuration of components described herein may also be used in combination with other processes, and is not limited to practice with only ground-based, combined cycle power generation systems, as described herein. Rather, the exemplary embodiment can be implemented and utilized in connection with many applications where a RDC system may be implemented.

Although specific features of various embodiments of the present disclosure may be shown in some drawings and not in others, this is for convenience only. In accordance with the principles of embodiments of the present disclosure, any feature of a drawing may be referenced and/or claimed in combination with any feature of any other drawing.

This written description uses examples to disclose the embodiments of the present disclosure, including the best mode, and also to enable any person skilled in the art to practice embodiments of the present disclosure, including making and using any devices or systems and performing any incorporated methods. The patentable scope of the embodiments described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A turbine engine assembly comprising:
a rotating detonation combustor configured to combust a fuel-air mixture formed at least partially from a primary fuel comprising methane; and
a fuel reformer configured to produce a secondary fuel, wherein said fuel reformer is further configured to channel a flow of the secondary fuel towards said rotating detonation combustor such that the fuel-air mixture further comprises the secondary fuel.

2. The turbine engine assembly in accordance with claim 1 further comprising a flow controller coupled between said rotating detonation combustor and said fuel reformer, said flow controller configured to regulate the flow of the secondary fuel channeled towards said rotating detonation combustor based on an operating condition of the turbine engine assembly.

3. The turbine engine assembly in accordance with claim 2, wherein said flow controller is further configured to channel the flow of the secondary fuel towards said rotating detonation combustor at least one of during startup of said turbine engine assembly, or as a rotational speed of said turbine engine assembly increases towards a steady state operating condition.

4. The turbine engine assembly in accordance with claim 3, wherein said flow controller is further configured to progressively reduce an amount of the secondary fuel channeled towards said rotating detonation combustor as the rotational speed of said turbine engine assembly increases towards the steady state operating condition.

5. The turbine engine assembly in accordance with claim 2, wherein said flow controller is further configured to stop the flow of the secondary fuel channeled towards said rotating detonation combustor when said turbine engine assembly reaches a steady state operating condition.

6. The turbine engine assembly in accordance with claim 2, wherein said rotating detonation combustor is configured to produce detonations from the fuel-air mixture having a cell size defined within a predetermined range, said flow controller further configured to regulate the flow of the secondary fuel such that the cell size of the fuel-air mixture is within the predetermined range.

7. The turbine engine assembly in accordance with claim 2, wherein said flow controller is further configured to regulate the flow of secondary fuel channeled towards said rotating detonation combustor is further based on at least one of an inlet pressure or an inlet temperature at said rotating detonation combustor, or an equivalence ratio of the fuel-air mixture.

8. The turbine engine assembly in accordance with claim 1 further comprising a heat exchange assembly configured to receive a flow of fuel, to transfer heat from said rotating detonation combustor to the flow of fuel such that a flow of heated fuel is formed, and to channel the flow of heated fuel towards said fuel reformer.

9. The turbine engine assembly in accordance with claim 8, wherein said heat exchange assembly comprises a hot side and a cold side, said rotating detonation combustor comprising said heat exchange assembly integrated therewith such that said hot side is defined by a portion of said rotating detonation combustor.

10. The turbine engine assembly in accordance with claim 8, wherein said heat exchange assembly comprises a heat exchanger located remote from said rotating detonation combustor.

11. A method of operating a turbine engine assembly, said method comprising:
producing a secondary fuel in a fuel reformer;
channeling a flow of the secondary fuel from the fuel reformer towards a rotating detonation combustor; and
combusting, in the rotating detonation combustor, a fuel-air mixture formed at least partially from a primary fuel including methane, and the secondary fuel.

12. The method in accordance with claim 11, wherein producing a secondary fuel comprises converting natural gas to produce the secondary fuel.

13. The method in accordance with claim 11, wherein combusting a fuel-air mixture comprises combusting the fuel-air mixture formed at least partially from natural gas including methane.

14. The method in accordance with claim 11 further comprising regulating the flow of the secondary fuel channeled towards the rotating detonation combustor based on an operating condition of the turbine engine assembly.

15. The method in accordance with claim 14, wherein regulating the flow of the secondary fuel comprises channeling the flow of the secondary fuel towards the rotating detonation combustor at least one of during startup of the turbine engine assembly, or as a rotational speed of the turbine engine assembly increases towards a steady state operating condition.

16. The method in accordance with claim 15, wherein regulating the flow of the secondary fuel comprises progressively reducing an amount of the secondary fuel channeled towards the rotating detonation combustor as the rotational speed of the turbine engine assembly increases towards the steady state operating condition.

17. The method in accordance with claim 14, wherein regulating the flow of the secondary fuel comprises stopping the flow of the secondary fuel channeled towards said rotating detonation combustor when the turbine engine assembly reaches a steady state operating condition.

18. The method in accordance with claim 14, wherein the rotating detonation combustor is configured to produce detonations from the fuel-air mixture having a cell size defined within a predetermined range, wherein regulating the flow of the secondary fuel comprises regulating the flow of the secondary fuel such that the cell size of the fuel-air mixture is within the predetermined range.

19. The method in accordance with claim 11 further comprising:
transferring heat from the rotating detonation combustor to the primary fuel such that a flow of heated fuel is formed; and
channeling the flow of heated fuel towards the fuel reformer.

20. The method in accordance with claim 11, wherein producing a secondary fuel comprises using one of oxygen or steam to produce the secondary fuel.
